(19) United States
(12) Patent Application Publication
(10) Pub. No.: US 2016/0254718 A1
(43) Pub. Date: Sep. 1, 2016

(54) SEGMENT CONDUCTORS, STATOR, ROTATING ELECTRICAL MACHINE, AND VEHICLE AND METHOD OF MANUFACTURING THE SEGMENT CONDUCTORS

(71) Applicant: Nidec Copal Corporation, Tokyo (JP)

(72) Inventors: Masakazu WATANABE, Tokyo (JP); Yoshinori FUKASAKU, Tokyo (JP); Masato IWASE, Tokyo (JP); Koki KUNII, Koriyama-shi (JP); Hirofumi NAGASAWA, Tokyo (JP); Shinji KOIKE, Saitama-shi (JP)

(73) Assignee: Nidec Copal Corporation, Tokyo (JP)

(21) Appl. No.: 15/049,720

(22) Filed: Feb. 22, 2016

(30) Foreign Application Priority Data
Feb. 26, 2015 (JP) 2015-037337
Feb. 26, 2015 (JP) 2015-037338
Jun. 16, 2015 (JP) 2015-120936

(51) Int. Cl. H02K 3/28; H02K 15/04

(52) U.S. Cl. CPC H02K 3/28; H02K 15/04

(57) ABSTRACT

A segment conductor that is a conductive element of a coil wound in a distributed winding in a stator core of a rotating electric machine is formed, through press forming and is provided with a pair of straight conductor portions and a bent conductor portion that connects together one end side of the pair of straight conductor portions. Moreover, one part of the segment conductor is formed, through press forming, so as to be thinner than another part. Specifically, a part that is exposed from the stator core is formed, through press forming, so as to be thinner than a part that is contained in a slot of the stator core. The stator has a structure wherein a plurality of segment conductors are disposed in a distributed winding in the stator core. The rotating electric machine is equipped with this stator. The vehicle is equipped with this rotating electric machine.

### CROSS-REFERENCE TO RELATED APPLICATIONS

The present application claims priority to Japanese Patent Application Nos. 2015-037337, filed Feb. 26, 2015, 2015-037338, filed Feb. 26, 2015, and 2015-120936, filed Jun. 16, 2015. These applications are incorporated herein by reference in their entirety.

### FIELD OF TECHNOLOGY

The present invention relates to a segment conductor, a stator, a rotating electric machine, a vehicle, and a manufacturing method for segment conductor.

### BACKGROUND

There are known needle-shaped conductor sequentially connected coils for rotating electric machines formed through inserting needle-shaped conductors (essentially U-shaped conductors), from the front side, into each of a plurality of slots formed in a stator core of a round cylindrical shape, and sequentially connecting the tip ends of the individual needle-shaped conductors, which protrude to the rear side of the stator core, to tip ends of other needle-shaped conductors (referencing, for example, Japanese Unexamined Patent Application Publication 2001-119881).

Moreover, there are known rotating electric machines structured from a stator that is equipped with a plurality of slots disposed in the circumferential direction, and stator windings made through connecting a plurality of coated segment conductors (referencing, for example, Japanese Unexamined Patent Application Publication 2013-005609).

However, it is desirable to increase the power of rotating electric machines used as power generators or motors, used in vehicles such as automobiles. Moreover, it is desirable to reduce the size of rotating electric machines. In particular, it is desirable to reduce the height of coil end portions exposed from stator cores of stators (to produce low profiles).

For example, when, in order to reduce the electrical resistance of the conductor in the coil of the stator, the cross-sectional area of the conductor is simply increased, this will cause the stator to be larger, through the increase in the height of the coil end portions, because a plurality of conductors are overlapped in the axial direction of the stator core.

Moreover, when U-shaped conductors are formed through a bending process on rectangular copper wires that are thick and that have a large cross-sectional area, for example, this produces internal stresses and strains at the bent parts.

Moreover, when the pair of legs portions of a U-shaped conductor are twisted and opened up, in order to insert to the U-shaped conductor into a slot in a stator core, this may produce faults such as cracking or bulging, through large internal stresses, large strains, embrittlement, or the like, at the bent portions.

In the present invention, the handling of such problems is an example of the problem to be solved. That is, objects are to provide segment conductors able to reduce internal stresses, and the like, so as to prevent the occurrence of cracking, and the like, to provide a stator equipped with this segment conductor, to provide a rotating electric machine equipped with this stator, to provide a vehicle equipped with this rotating electric machine, and to provide a method for manufacturing a segment conductor that enables easy manufacturing of a segment conductor with little internal stress, through a reduction in thickness in one part.

Moreover, in the present invention, the handling of such problems is an example of the problem to be solved. Objects are to provide a segment conductor wherein the height of the coil end portions that are exposed from the stator core is low, with low electrical resistance, to provide a stator equipped with this segment conductor, to provide a rotating electric machine equipped with this stator, to provide a vehicle equipped with this rotating electric machine, and the like.

### SUMMARY

In order to achieve such an object, the segment conductor (bent intermediating body) of the present invention is equipped with at least the following structures:

a segment conductor that is a conductive element of a coil that is wound in a distributed winding in a stator core of a rotating electric machine:

formed through press forming, and comprising a pair of straight conductor portions and a bent conductor portion for connecting together one end side of the pair of straight conductor portions.

The stator of the present invention has a structure wherein a plurality of segment conductors are arranged, through distributed winding, in a stator core.

The rotating electric machine according to the present invention is characterized by the provision of the stator according to the invention set forth above.

The vehicle according to the present invention is characterized by the provision of the rotating electric machine according to the invention set forth above.

The method for manufacturing the segment conductor according to the present invention is provided with at least the following structures:

a manufacturing method for a segment conductor that is a conductive element of a coil that is wound in a distributed winding in a stator core of a rotating electric machine; and

a step for forming, through press forming a metal material, a segment conductor provided with a pair of straight conductor portions and a bent conductor portion that connects together one end side of the pair of straight conductor portions.

Moreover, the segment conductor (bent intermediating body) according to the present invention is provided with at least the following structures:

a segment conductor that is a conductive element of a coil that is wound in a distributed winding in a stator core of a rotating electric machine; and

having a rectangular cross-section, and provided with a pair of straight conductor portions and a bent conductor portion that connects together one end side of the pair of straight conductor portions, where the cross-sectional thickness of the part of the bent conductor portion that is disposed exposed from the stator core is thinner than the cross-sectional thickness of the parts of the straight conductor portions that are disposed contained within the slots of the stator core.

The stator of the present invention has a structure wherein a plurality of segment conductors are arranged, through distributed winding, in a stator core.

The rotating electric machine according to the present invention is characterized by the provision of the stator according to the invention set forth above.

The vehicle according to the present invention is characterized by the provision of the rotating electric machine according to the invention set forth above.

The present invention enables the provision of a segment conductor wherein internal stresses, and the like are small, preventing cracking, and the like.

Moreover, the present invention enables the provision of a stator equipped with this segment conductor.

Moreover, the present invention enables the provision of a rotating electric machine provided with that stator.

Furthermore, the present invention enables the provision of a vehicle provided with this rotating electric machine.

Moreover, the manufacturing method for a segment conductor according to the present invention enables easy manufacturing of a segment conductor wherein one part is thin, and the internal stress is small.

The present invention enables the provision of a segment conductor wherein the electric resistance is small and wherein the height of the coil end portion that is exposed from the stator core is low.

Moreover, the present invention enables the provision of a stator equipped with this segment conductor.

Moreover, the present invention enables the provision of a rotating electric machine provided with that stator.

Furthermore, the present invention enables the provision of a vehicle provided with this rotating electric machine.

### BRIEF DESCRIPTION OF THE DRAWINGS

FIG. 1 is a perspective diagram illustrating an example of a stator of a rotating electric machine according to an example according to the present invention.

FIG. 2 is a side view of a stator according to an example of the present invention.

FIG. 3 is a diagram illustrating an example of a segment conductor according to an example according to the present invention.

FIG. 4(a) is a perspective view illustrating an example of a plate-shaped source material used in an example of a method for manufacturing a segment conductor.

FIG. 4(b) is a plan view of a press-formed segment conductor formed by an example of a method for manufacturing a segment conductor.

FIG. 4(c) is a side view of the press-formed segment conductor formed by the example of a method for manufacturing a segment conductor.

FIG. 5 is a diagram illustrating an example of a stator core and a segment conductor.

FIG. 6 is a diagram illustrating an example of the state wherein an end portion of a segment conductor has been bent.

FIG. 7 is a plan view illustrating an example of a stator core and a segment conductor.

FIG. 8 is a diagram illustrating an example of a state wherein a plurality of segment conductors have is arranged on a stator core.

FIG. 9 is a plan view illustrating an example of the stator core and the plurality of segment conductors illustrated in FIG. 8.

FIG. 10(a) is a perspective view illustrating another example of a segment conductor according to an example of the present invention.

FIG. 10(b) is a front view illustrating another example of a segment conductor according to an example of the present invention.

FIG. 10(c) is a side view illustrating another example of a segment conductor according to an example of the present invention.

FIG. 11 is a conceptual diagram for explaining an example of a vehicle equipped with a rotating electric machine according to an example according to the present invention.

### DETAILED DESCRIPTION

A segment conductor (a divided lead wire) according to an example according to the present invention is a conductive element of a coil that is wired through distributed winding in a stator core of a rotating electric machine. The segment conductor is formed through press forming, and is provided with a pair of straight conductor portions and a bent conductor portion that connects together one end side of the pair of straight conductor portions. The stator of the rotating electric machine has a structure wherein a plurality of segment conductors are arranged, through distributed winding, in a stator core. Moreover, a vehicle is equipped with this rotating electric machine.

The segment conductor has a rectangular cross-section, and is provided with a pair of straight conductor portions and a bent conductor portion that connects together one end side of the pair of straight conductor portions, where the cross-sectional thickness of the part of the bent conductor portion that is disposed exposed from the stator core is thinner than the cross-sectional thickness of the parts of the straight conductor portions that are disposed contained within the slots of the stator core. The stator of the rotating electric machine has a structure wherein a plurality of segment conductors are arranged, through distributed winding, in a stator core. Moreover, a vehicle is equipped with this rotating electric machine.

Examples according to the present invention will be explained below, in reference to the drawings. While the examples of the present invention include the detail in the drawings, there is no limitation thereto. Note that in the explanations of the various drawings below, those parts that are the same as parts already explained will be assigned identical reference symbols, and redundant explanations will be partially omitted.

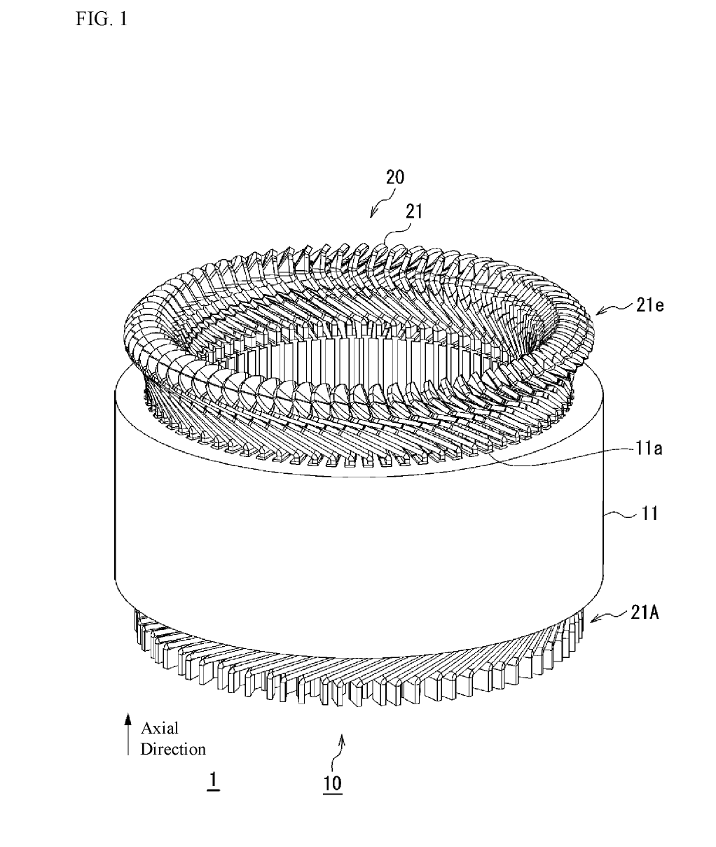

FIG. 1 is a perspective diagram illustrating an example of a stator 10 of a rotating electric machine 1 according to an example according to the present invention.

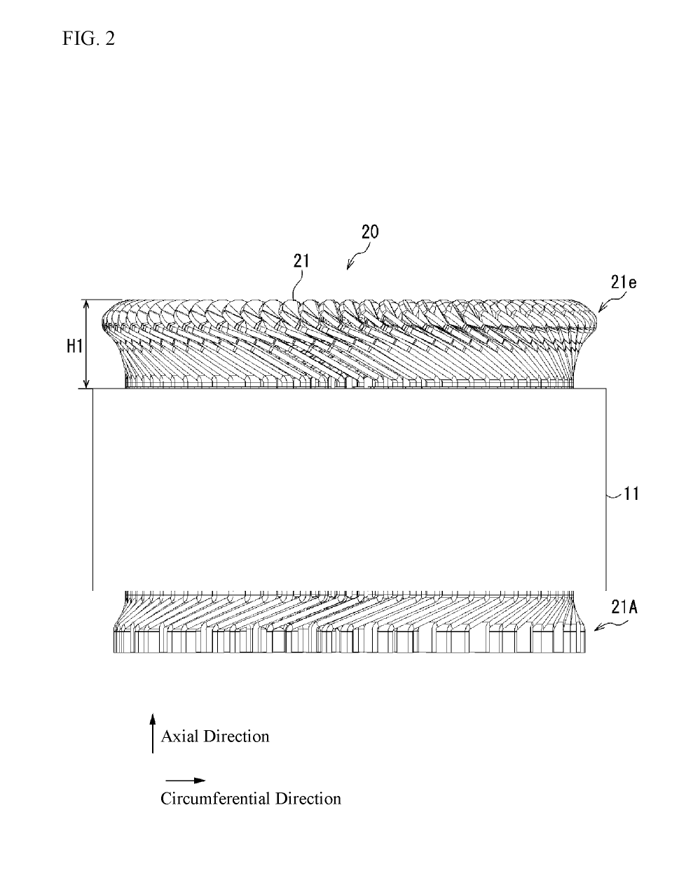

FIG. 2 is a side view of a stator according to an example according to the present invention.

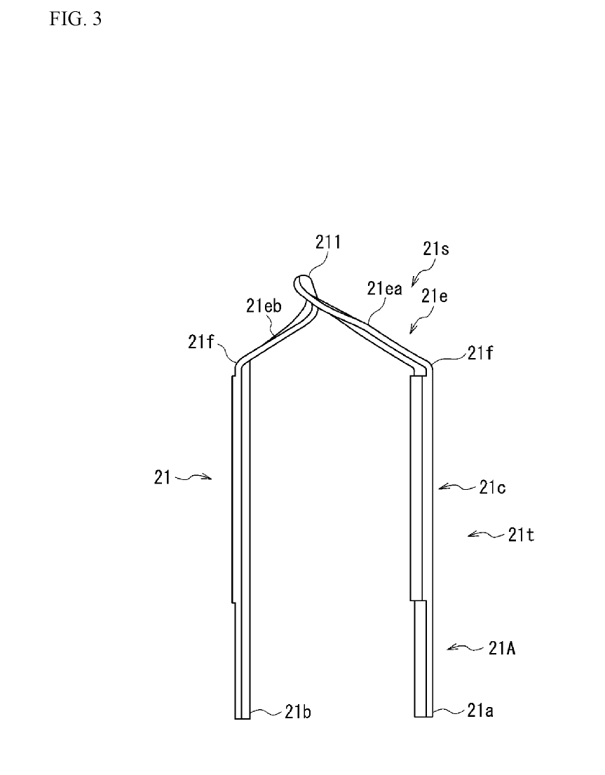

FIG. 3 is a diagram illustrating an example of a segment conductor 21 according to an example according to the present invention. Note that FIG. 1 and FIG. 2 illustrate a state wherein the bottom end portion of the segment conductor is not connected.

The stator 10 of the rotating electric machine 1 has a stator core 11 and a plurality of segment conductors 21.

The stator core 11 is formed into a round column shape, where a plurality of slots 11a that pass through, in the axial direction, is provided in the vicinity of the inner peripheral portion thereof. These slots 11a are formed at prescribed intervals along the circumferential direction of the inner periphery of the stator core 11. Moreover, these slots 11a are formed radiating in the radial direction.

The segment conductor 21 is formed in a U shape, and has a pair of leg portions. The segment conductor 21 is formed from a metal material such as copper. A segment conductor 21 is disposed in each of a plurality of slots 11a that are formed in the stator core 11, inserted from the front side (toward the top in FIG. 1 and FIG. 2), protruding to the rear side of the stator core 11 (toward the bottom in FIG. 1 and FIG. 2). The protruding tip end portions of the segment conductors 21 are bent and connected sequentially electrically to the tip end portions of other segment conductors, as prescribed, to form a coil group 20 of the rotating electric machine.

In the present invention, the segment conductors 21 are disposed in a distributed winding in the stator core of the stator 10. Specifically, in the present example 72 slots 11a (grooves) are formed in the stator core 11, to form an eight-pole winding. In this case, the leg portions of the pairs of segment conductors 21 are inserted spanning nine slots. Note that the stator is not limited to this form. For example, the form may be one wherein X slots 11a (grooves) are formed in the stator core 11, an N-pole winding is formed, and the pairs of leg portions of the segment conductors 21 are inserted spanning M slots 11a.

As illustrated in FIG. 1 and FIG. 2, the coil end portion 21e that is disposed exposed from the top portion of the stator core 11 (the first coil end portion: the base end-side coil end portion) is structured from a plurality of segment conductors 21. In the coil end portion 21e, a plurality of segment conductors 21 is disposed overlapping in the axial direction of the stator core 11, without being connected to each other.

Moreover, this is the same for the coil end portion 21A, which is a part that is disposed exposed from the bottom portion of the stator core 11 (the second coil end portion: the opposite base end side coil end portion), where a plurality of segments in the conductors 21 is disposed overlapping in the axial direction of the stator core 11, without being connected together. Additionally, electric terminals (not shown) for a three-phase winding are provided on the bottom portion side of the stator core 11.

In an example according to the present invention, the coil end portions 21e, which are parts that are disposed exposed from the stator core 11, are formed so as to be thin, where the inclination angle is specified to be small, so the height H1 of the coil end portion 21e is small.

### Segment Conductor 21 (Bent Intermediating Body)

As illustrated in FIG. 3, the segment conductor 21 is a rectangular wire that is formed in a U shape, and has a pair of leg portions. Specifically, the segment conductor 21 has a rectangular cross-section, and is provided with a pair of straight conductor portions 21t and a bent conductor portion 21s that connects together one end side of the pair of straight conductor portions 21t. Moreover, in the segment conductor 21, the cross-sectional thickness of the parts of the bent conductor portion 21s that are disposed exposed from the stator core (the coil end portions 21e and 21A) are formed so as to be thinner than the cross-sectional thickness of the parts of the straight conductor portions 21t that are disposed contained within the slots of the stator core (the straight portions 21c). Moreover, the part that is disposed exposed from the top portion of the stator core (the coil end portion 21e) is formed in essentially a U shape, and has a head portion 211 and leg portions 21ea and 21eb, that extend to each of the straight portions 21c from the head portion 211, connected to the straight portions 21c through bent portions 21f. Moreover, the parts that are disposed exposed from the bottom portion of the stator core (the coil end portions 21A) have leg portions 21a and 21b that extend from each of the straight portions 21c.

In the present example, the parts that are disposed exposed from the stator core are specified to have no more than half the thickness of the parts that are disposed contained within the slots of the stator core (the straight portions 21c).

### Method for Manufacturing the Segment Conductor

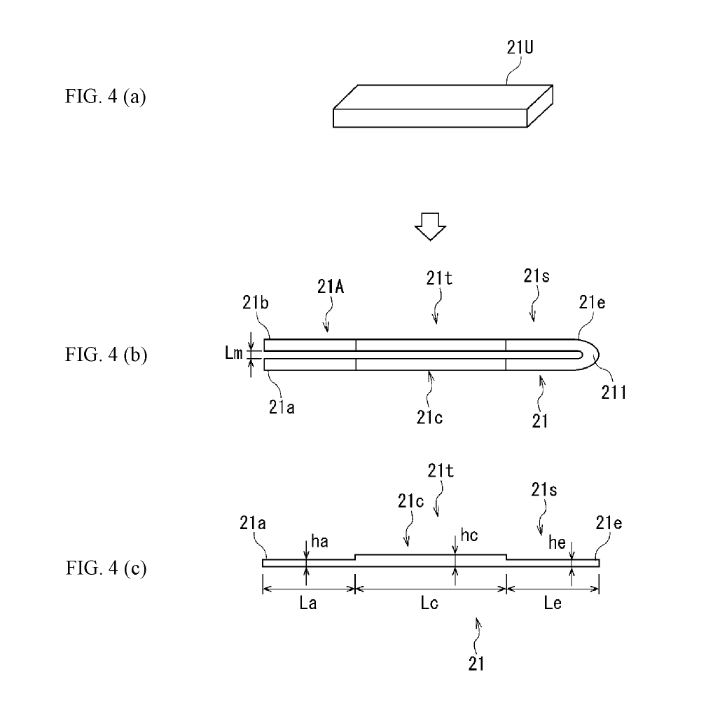

FIG. 4 is a diagram illustrating an example of a method for manufacturing a segment conductor according to an example according to the present invention. Specifically, FIG. 4(a) is a perspective view illustrating an example of a plate-shaped source material, FIG. 4(b) is a plan view of a press-formed segment conductor, and FIG. 4(c) is a side view of a press-formed segment conductor.

The method for manufacturing the segment conductor includes a step for forming the segment conductor through press forming, a step for opening up the segment conductor into a U shape, and the like. In this press forming, one part of the segment conductor is formed so as to be thinner than another part. Specifically, in this press forming, the parts that are to be disposed exposed from the stator core are formed so as to be thinner than the parts that are to be disposed contained within a slot of the stator core.

Specifically, as illustrated in FIG. 4(a), first a metal material, such as copper, is prepared, where the plate-shaped metal material 21U is pressed to form the U-shaped segment conductor 21, as illustrated in FIG. 4(b) and FIG. 4(c). More specifically, the plate-shaped metal material 21U is press-formed (a thickness-reducing machining step) and through providing a step so that the cross-sectional thickness of the parts that are to be disposed exposed from the stator core (the coil end portions 21e and 21A) will be thinner than the cross-sectional thickness of the parts that are to be disposed contained within the slot of the stator core (the straight portions 21c). Following this, this piece is subjected to a punching process, using a die, or the like, to be punched into a U shape. This makes it possible to form the segment conductor easily.

In the example illustrated in FIG. 4, a gap with a spacing of Lm is formed between the leg portions 21a and 21b. Moreover, in the example illustrated in FIG. 4, the length Lc and the thickness hc are specified for the straight portions 21c that are disposed contained within the slots of the stator core, the length Le and the thickness he are specified for a part that is disposed exposed from the stator core (the first coil end portion 21e), and the length La and the thickness ha are specified for parts that are disposed exposed from the stator core (the second coil end portions 21A). The thicknesses ha and he are less than the thickness hc. The thicknesses ha and he are, for example, specified so as to be no more than half of the thickness hc.

For example, in the present example of the distance Lm may be specified as about 1 mm, the length Lc may be specified as about 60 mm, the length La may be specified as about 37 mm, the length Le may be specified as about 37 mm, the thickness hc may be specified as about 2.8 mm, the thickness ha may be specified as about 1.2 mm, and the thickness he may be specified as about 1.2 mm.

Given this, the segment conductor 21 that is illustrated in FIG. 3 is formed by twisting and opening up the leg portions 21a and 21b of the U-shaped segment conductor 21, which is a rectangular wire that has stepped portions.

Note that the method for manufacturing the segment conductor 21 is not limited to the example set forth above. For example, the parts that are disposed exposed from the stator core may be formed so that the cross-sectional thicknesses thereof are thinner than the parts disposed contained within the slots of the stator core through prescribed processes such as cutting processes, or the like.

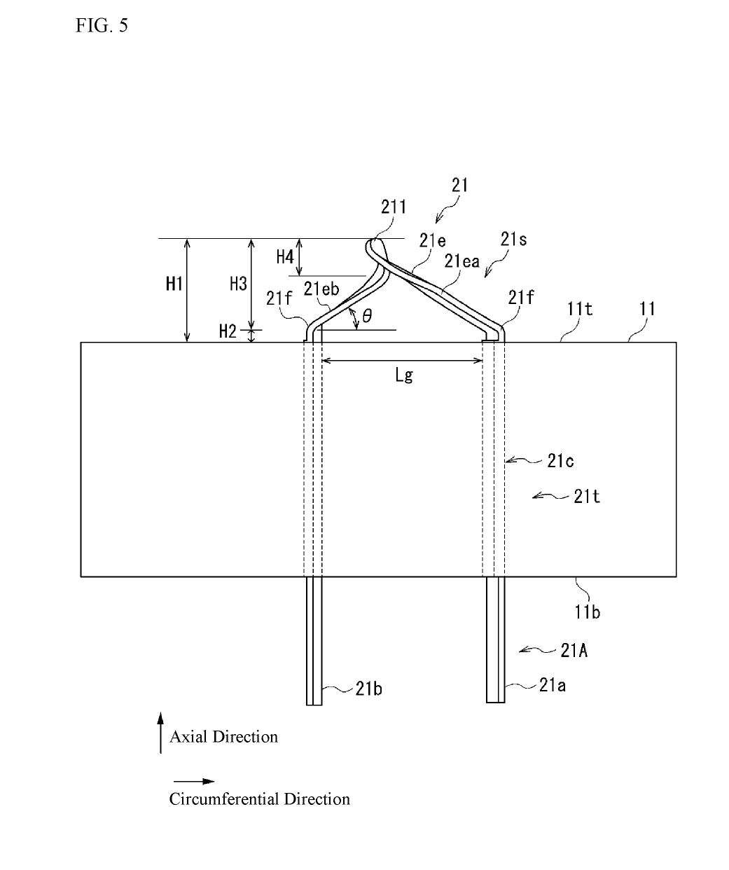

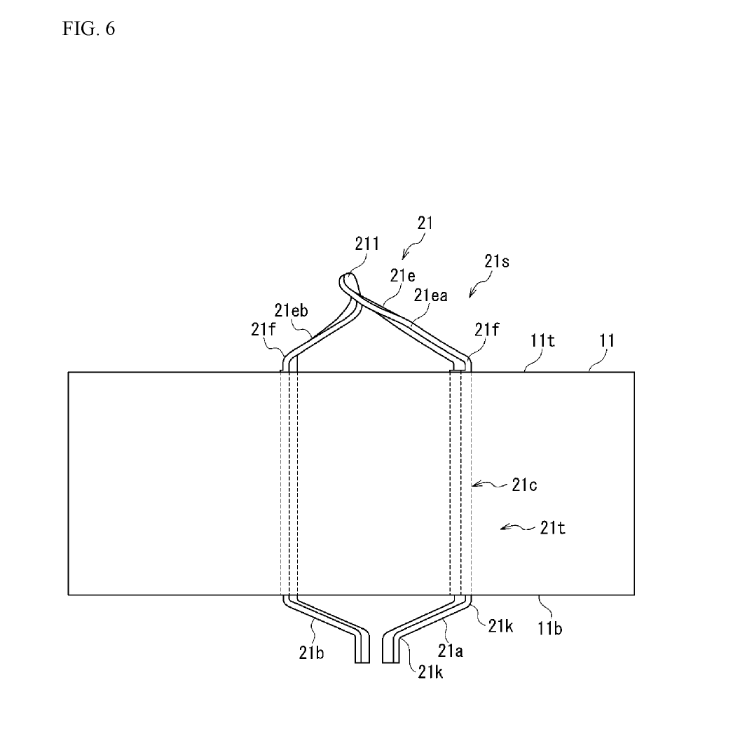

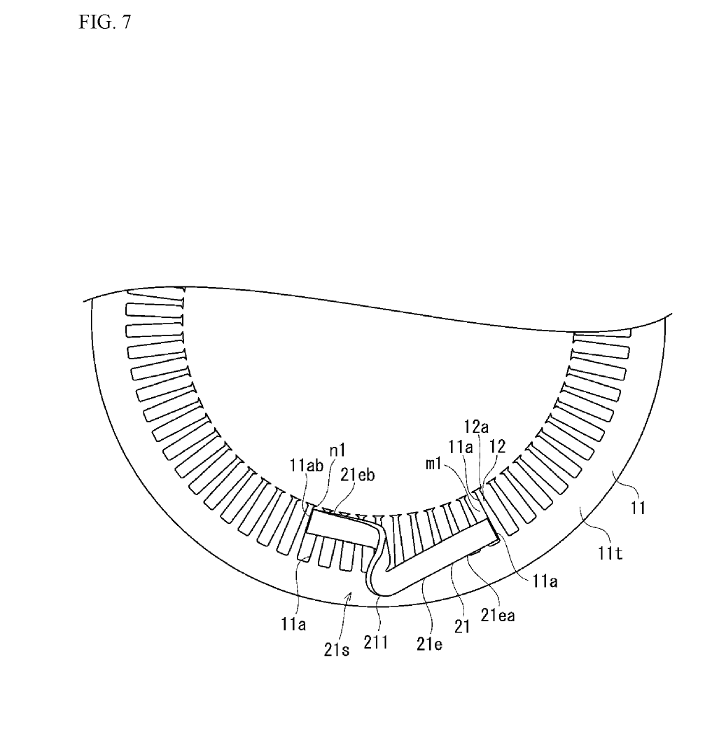

FIG. 5 is a diagram illustrating an example of a stator core 11 and a segment conductor 21. FIG. 6 is a diagram illustrating an example of a state wherein the end portions of the segment conductor 21 are bent. FIG. 7 is a plan view illustrating an example of a stator core 11 and a segment conductor 21.

Following this, the leg portions 21a and 21b of the segment conductor 21 are inserted into slots 11a of the stator core 11 from the top portion 11t side (the front side) toward the bottom portion 11b side. In the present example, 72 slots 11a (grooves) are formed in the stator core 11, and the pair of leg portions of the segment conductor are inserted into respective slots n1 and m1, spanning a plurality of slots (nine slots). Note that protruding portions 12, which protrude from the outer peripheral portion toward the inner peripheral side are formed on the inner periphery of the stator core 11, and the slots 11a are formed between these protruding portions 12. Extending portions 12a, which extend in the circumferential direction, are formed on the tip end portions of the protruding portions 12. Straight portions of the rectangular wire (which has a rectangular cross-section) of the segment conductors are inserted into two locations, on the inner peripheral side and the outer peripheral side, of the individual slots 11a.

As illustrated in FIG. 5, the height H1 of the coil end portion 21e that protrudes from the top portion 11t of the stator core 11 is the sum of the height H2 from the top portion 11t of the stator core 11 to the bent portion 21f and the height H3 from the bent portion 21f to the top end portion of the head portion 211. The smaller the inclination angle θ of the lead wire portion of the coil end portion 21e, the lower the height H1 of the coil end portion 21e.

Moreover, the spacing Lg between the pair of leg portions in a segment conductor is determined by the distance between the slots into which they will be inserted.

Note that the height H4 of the head portion 211 can be reduced through inclining the head portion 211 to an angle, rather than having the head portion 211 standing in the axial direction (the vertical direction in FIG. 5). In this case, the height H1 of the coil end portion 21e can be reduced further.

Following this, the leg portions 21a and 21b, which protrude from the bottom portion 11b of the stator core 11, are bent at the bent portions 21k, as illustrated in FIG. 6.

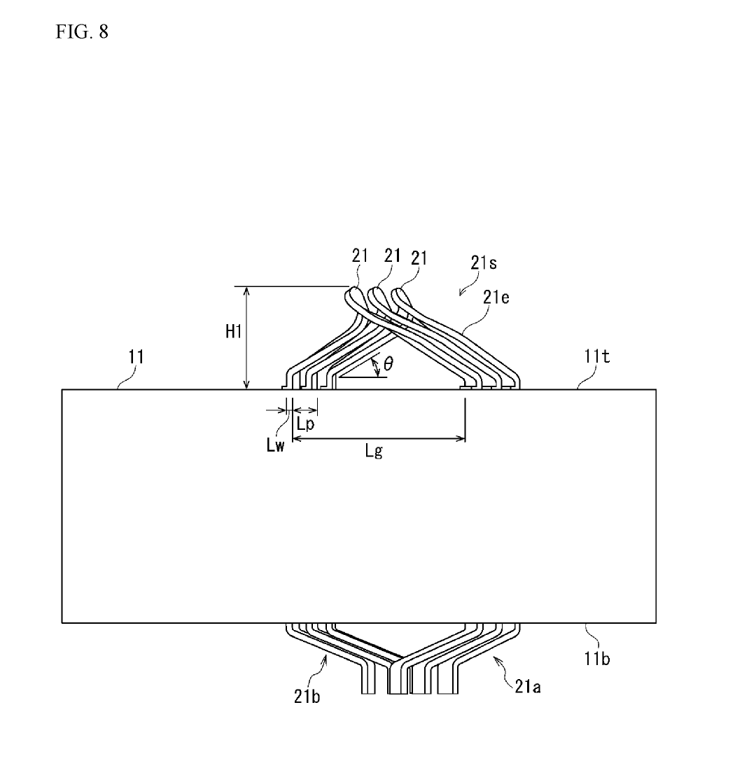

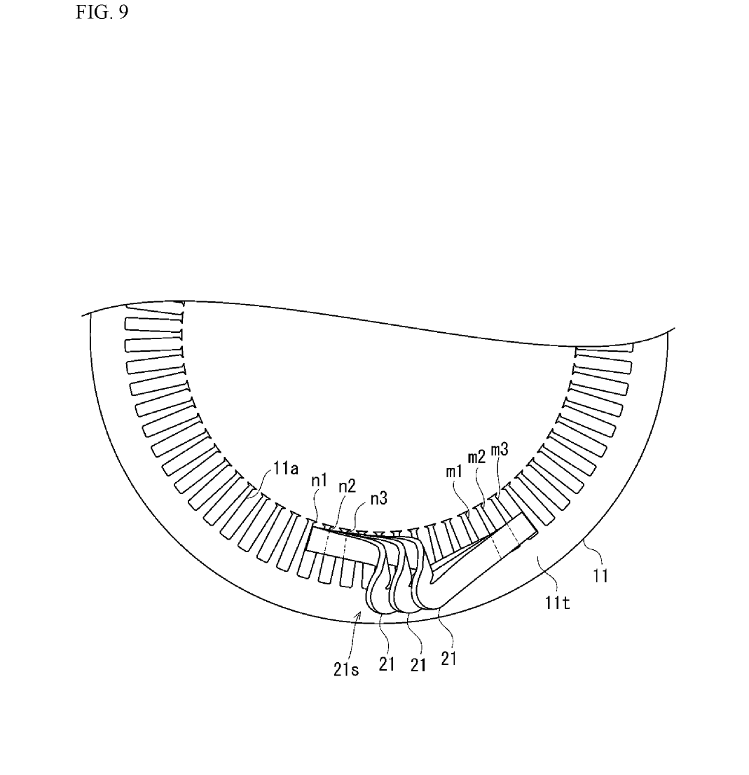

FIG. 8 is a diagram illustrating an example of the state wherein a plurality of segment conductors 21 are disposed on the stator core 11. FIG. 9 is a plan view illustrating an example of the stator core 11 and the plurality of segment conductors 21 that are illustrated in FIG. 8.

Given this, the plurality of segment conductors 21 are inserted into the slots 11a of the stator core 11, as illustrated in FIG. 8 and FIG. 9. Specifically, the leg portions of the pair in the segment conductor 21 that is adjacent to the segment conductor 21 that is inserted into slots n1 and ml are inserted, respectively, into slots n2 and m2, after which the pair of leg portions of the segment conductor 21 that is adjacent thereto are inserted, respectively, into slots n3 and m3. The leg portions 21a and 21b that protrude from the bottom portion 11b of the stator core 11 are then bent.

In this way, a plurality of segment conductors is inserted sequentially into prescribed slots of the stator core and the leg portions that are protruding from the bottom portion of the stator core are bent (referencing FIG. 1 and FIG. 2). Thereafter, the leg portions of a segment conductor, that are protruding from the bottom portion of the stator core, are connected electrically, through welding, or the like, to leg portions of other segment conductors, as prescribed, to form a coil group of the distributed winding.

As illustrated in FIG. 8, although the height H1 of the coil end portion 21e that protrudes from the top portion 11t of the stator core 11 is smaller the smaller the inclination angle θ of the lead wire portion of the coil end portion 21e, if the inclination angle θ were too small this would result in contact with the adjacent segment conductor 21.

The inclination angle θ and the height H1 are determined by the line width Lw of the coil end portions 21e of the segment conductors, the number of slots, the pitch Lp of the adjacent segment conductors (the spacing of adjacent slots), the spacing Lg of the pair of leg portions in a segment conductor (the number of slots spanned), and the like.

In the present example, the segment conductor 21 is specified so that, in a state wherein it is disposed in the slots in the stator core 11, the inclination angle θ of the part that is exposed from the stator core 11 will be no more than 40°. Preferably, the inclination angle is specified to be no more than 35°. The lower limit value for the inclination angle θ is about 20°.

Moreover, if, as described above, the length Lc of the segment conductor is specified as about 60 mm, the length La is specified as about 37 mm, the length Le is specified as about 37 mm, the thickness hc is specified as about 2.8 mm, the thickness ha is specified as about 1.2 mm, and the thickness he is specified as about 1.2 mm, then the height of the base end-side coil end portion is structured so as to be no more than 20 mm, and preferably no more than 18 mm.

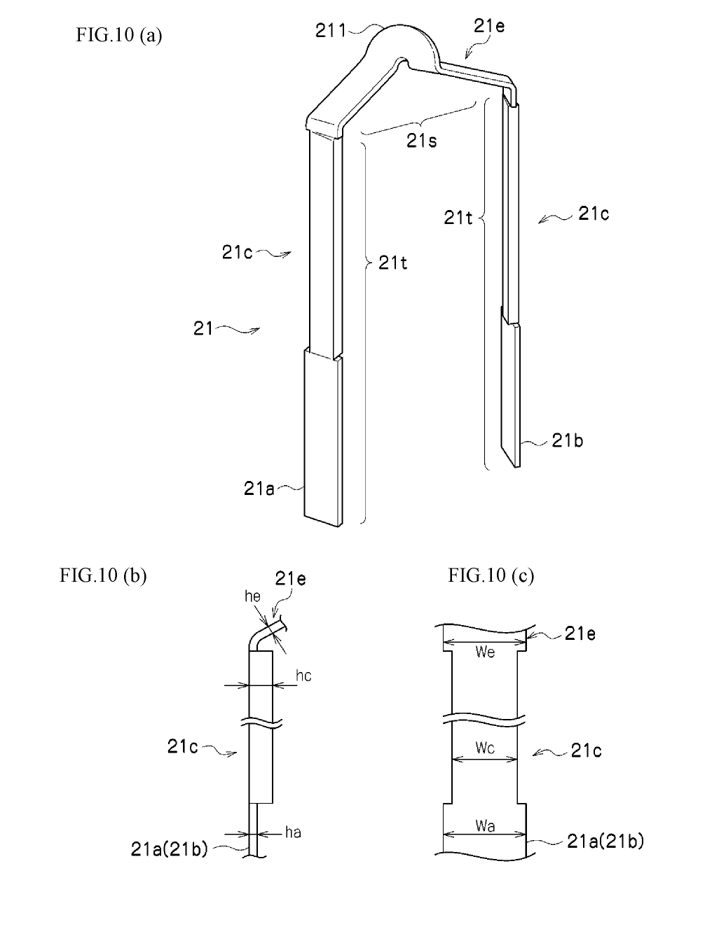

FIG. 10 illustrates another example of a segment conductor 21. The parts that are the same as that which has been explained above are assigned identical reference symbols, and redundant explanations are omitted. FIG. 10(a) is an overall perspective view, FIG. 10(b) is a partial side view, and FIG. 10(c) is a partial front view.

As with the example described above, the segment conductor 21 has a rectangular cross-section, and is provided with a pair of straight conductor portions 21t and a bent conductor portion 21s that connects together one end side of the pair of straight conductor portions 21t, where the cross-sectional thickness he of the part of the bent conductor portion 21s that is disposed exposed from the stator core (the coil end portion 21e) is formed thinner than the cross-sectional thickness hc of the parts of the straight conductor portions 21t that are disposed contained within the slots of the stator core (the straight portions 21c). Moreover, the cross-sectional thickness ha of the leg portions 21a and 21b is formed so as to be thinner than the cross-sectional thickness hc of the part of the straight conductor portion 21t that is disposed contained with in the stator core slots (the straight portions 21c).

Moreover, in this example the width We of the part of the bent conductor portion 21s that is disposed exposed from the stator core (the coil end portion 21e) is formed so as to be larger than the width Wc of the parts of the straight conductor portion 21t that are disposed contained in the slots of the stator core (the straight portions 21c), and the width Wa of the leg portions 21a and 21b is also formed to be larger than the width Wc of the parts of the straight conductor portion 21t that are disposed contained within the slots of the stator core (the straight portions 21c). Forming in this way causes the cross-sectional area of the bent conductor portion 21f and of the parts of the leg portions 21a and 21b that are disposed exposed from the stator core to be essentially equal to the cross-sectional area of the parts of the straight conductor portion 21c that are contained in the slots of the stator core. This enables the cross-sectional area of the segment conductor 21, as a whole, to be essentially constant, to provide a segment conductor 21 that has, overall, an essentially uniform electrical resistance while reducing the profile of the bent conductor portion 21s.

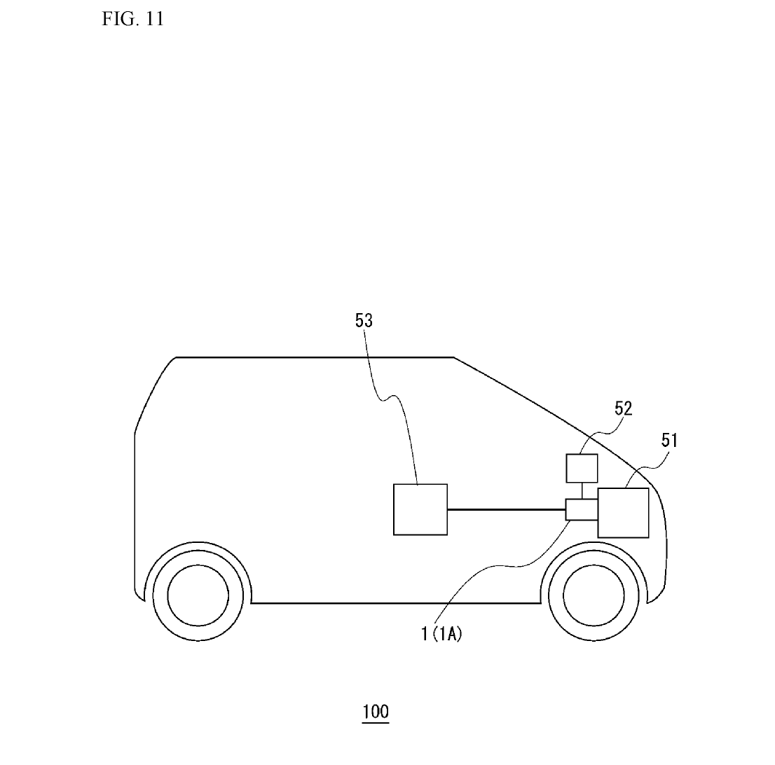

FIG. 11 is a conceptual diagram for explaining an example of a vehicle 100 that is provided with a rotating electric machine 1 (1A) according to an example according to the present invention.

The rotating electric machine 1 (1A) has a stator wherein the segment conductors with the U-shaped rectangular wire, described above, are disposed in a distributed winding in the stator core, a rotor, and the like. The vehicle 100 is provided with a rotating electric machine 1. Specifically, the vehicle 100, illustrated in FIG. 11, has an engine 51, a first battery 52, such as a lead battery, or the like, a second battery 53, such as a lithium ion battery, or the like, that is provided if necessary, a rotating electric machine 1 (1A), and so forth. The engine 51 and the rotor of the rotating electric machine 1 (1A) are connected by power transmitting means, such as a belt, so as to enable transmission of power therebetween. The first battery 52 and the second battery 53 are connected electrically to the rotating electric machine 1 (1A).

In the present example, the rotating electric machine 1 (1A) is used as an electric power generator with a motor function. The stator is small, and thus the rotating electric machine 1 (1A) is small as well. In the rotating electric machine 1 (1A), the rotor is rotated by the power of the engine, to generate electric power, which quickly charges the battery. When the engine 51 is started up (or restarted), the rotating electric machine 1 (1A) functions as a high-power starter. Moreover, when the vehicle accelerates, the rotating electric machine 1 (1A) provides motorized assistance to the engine 51.

Note that the vehicle 100 and the rotating electric machine 1 (1A) are not limited to the example set forth above.

As explained above, the segment conductor 21 according to the example according to the present invention is a conductive element of coils that are interconnected in a distributed winding on the stator core 11 of the rotating electric machine 1. The segment conductor 21 is formed through press forming, and is provided with a pair of straight conductor portions 21t and a bent conductor portion 21s that connects together one end side of the pair of straight conductor portions 21t. Specifically, the segment conductor has a rectangular cross-sectional shape, and is formed so as to have a U shape.

That is, the segment conductor 21 is formed through press forming, enabling the internal stress and strain, and the like, to be small, making it possible to prevent the occurrence of cracking, and the like.

Moreover, the segment conductors 21 that are to be disposed in distributed windings in the stator core 11 of the stator 10 of the rotating electric machine, described above, can be manufactured easily through press forming the metal material.

Moreover, even if the pair of straight conductor portions 21t (leg portions) of the segment conductor 21 is twisted and opened up in order to insert the pair of straight conductor portions 21t into the slots 11a of the stator 10, still the internal stress and strain, and the like, in the bent conductor portion 21s is small, so there will be no occurrence of brittlization, cracking, bulging, or the like.

Additionally, one part of the segment conductor 21 is formed through press forming so as to be thinner than another part. Specifically, in this press forming, the parts that are to be disposed exposed from the stator core (the core in portions 21e and 21A) are formed so as to be thinner than the parts that are to be disposed contained within a slot 11a of the stator core 11.

Moreover, a segment conductor having the effects set forth above can be manufactured easily because one part of the segment conductor is formed, through press forming, so as to be thinner than another part.

As a comparative example, it is not possible to manufacture a segment conductor wherein one part of the segment conductor is thinner than another part by merely punching, into a U shape, a copper plate that has a uniform thickness.

Note that, in an example according to the present invention, the punching into the U shape may be performed after forming, through press-forming, one part of the segment conductor 21 so as to be thinner than another part.

Moreover, in an example according to the present invention, the desired U shape may be formed through causing, through press-forming, one part of the segment conductor 21 to be thinner than another part, after punching, into essentially a U shape, a metal material that has a uniform thickness, such as a copper plate.

Moreover, the stator 10 according to an example according to the present invention has a structure wherein the plurality of segment conductors 21, described above, are disposed in the stator core 11 in a distributed winding. Because of this, the inclination angle of the lead wires of the coil end portions 21e is small, and the height of the coil end portions 21e is small.

As explained above, the segment conductor 21 according to the example according to the present invention is a conductive element of coils that are interconnected in a distributed winding on the stator core 11 of the rotating electric machine 1. The segment conductor has a rectangular cross-section, and is provided with a pair of straight conductor portions 21t and a bent conductor portion 21s that connects together one end side of the pair of straight conductor portions 21t, where the cross-sectional thickness of the part of the bent conductor portion 21s that is disposed exposed from the stator core 11 is thinner than the cross-sectional thickness of the parts of the straight conductor portions 21t that are disposed contained within the slots 11a of the stator core 11 (the straight portions 21c).

Moreover, the stator according to an example according to the present invention has a structure wherein the plurality of segment conductors, described above, are disposed in the stator core in a distributed winding.

That is, because, in the stator core 11, the cross-sectional thickness of the parts of the bent conductor portion 21s that are disposed exposed from the stator core 11 are thinner than the cross-sectional thickness of the parts of the straight conductor portions 21t that are disposed contained within the slots 11a of the stator core 11 (the straight portions 21c), the inclination angle θ of the lead wires of the parts that are disposed exposed from the stator core 11 (the coil end portions 21e) can be reduced, so that the heights of the parts that are exposed from the stator core 11 will be low, even when a plurality of conductors is disposed overlapping in the axial direction of the stator core 11.

That is, this makes it possible to provide a stator that is small in the axial direction, specifically, a stator wherein the height of the parts exposed from the stator core is small.

Moreover, because in the parts of the straight conductor portions 21t that are disposed contained within the slots 11a of the stator core 11 (the straight portions 21c), the cross-sectional thickness is larger than in the parts of the bent conductor portion 21s that is disposed exposed from the stator core 11, the electrical resistance of the segment conductor 21 is relatively smaller. As in the example illustrated in FIG. 10, the electrical resistance can be caused to be uniform through having the cross-sectional area of the segment conductor 21 be constant overall.

Moreover, the parts of the segment conductor 21 according to the example according to the present invention that are disposed exposed from the stator core 11 (included in the bent conductor portion 21s) are specified so as to be no more than half the thickness of the parts that are disposed contained within the slots 11a of the stator core 11.

That is, the inclination angle of the lead wires of the parts that are disposed exposed from the stator core 11 (the coil end portions on one side) can be made extremely small.

Note that the parts of the segment conductor 21 that are disposed exposed from the stator core 11 (the coil end portions) having a thickness that is no less than about 25% of the thickness of the parts that are contained within the slots 11a of the stator core 11 enables the electrical resistance value of the parts that are disposed exposed from the stator core 11 to be kept low while enabling the inclination angle of the lead wires in the parts that are exposed from the stator core 11 to be extremely small.

Moreover, in a state wherein the segment conductors 21 according to the present example are disposed in the slots 11a of the stator core 11, the inclination angle of the parts that are disposed exposed from the stator core 11 is specified to be less than 40°. Preferably, the inclination angle is specified to be no more than 35°.

Additionally, from the perspective of the thickness of the coil end portions, the spacing between adjacent segment conductors, and the overlapping of the lead wires in the axial direction, the lower limit value for the inclination angle is about 20°.

Moreover, the rotating electric machine according to an example of the present invention is provided with the stator set forth above. Because of this, the motor, as a rotating electric machine, is small and has high power. Moreover, the power generator, as a rotating electric machine, is small and has high-power electrical generation. Moreover, a power generator with a motor function, as a rotating electric machine, is small and has high power, and also has high-power electrical generation.

Moreover, the vehicle according to the present invention is provided with a rotating electric machine as described above. When this rotating electric machine is used as a power generator, the space for installing in the vehicle can be kept small, enabling a battery that is installed in the vehicle to be charged quickly. Moreover, when the rotating electric machine is used as a motor, the space for installing in the vehicle can be kept small, enabling use as a high-power starter when starting (restarting) the engine. Moreover, when the vehicle is accelerating, providing motorized assistance to the engine can improve acceleration performance, reduce fuel consumption, and the like. Moreover, when the rotating electric machine is used as a power generator with a motor function, the space for installing in the vehicle can be kept small, enabling the battery to be charged rapidly, as described above, and making it possible to improve acceleration performance and reduce fuel consumption through motorized assistance at the time of starting up (or restarting) the engine and when the vehicle is accelerating.

While the examples of the present invention were described in detail referencing the drawings, the specific structures are not limited to those in these examples, but rather design changes, and the like, within a range that does not deviate from the spirit or intent of the present invention are included within the present invention.

Moreover, insofar as there are no particular contradictions or problems in purposes, structures, or the like, the details that are described for the examples illustrated in the various drawings described above may be combined.

Moreover, the details described in each of the drawings can be respectively independent examples, and the examples of the present invention are not limited to a single example combining each of the drawings.

What is claimed is:

1. A segment conductor that is a conductive element of a coil that is wound in a distributed winding in a stator core of a rotating electric machine is formed through press forming, and comprising:
a pair of straight conductor portions; and
a bent conductor portion connecting together one end side of the pair of straight conductor portions.

2. The segment conductor as set forth in claim 1, wherein:
one part of the segment conductor is thinner than another part,
wherein the thinner part is press formed.

3. The segment conductor as set forth in claim 1, wherein:
an exposed part of the segment conductor that is disposed exposed from the stator core is thinner than a part that is disposed contained in a slot of the stator core,
wherein the exposed part is press formed.

4. The segment conductor as set forth in claim 1, wherein
the segment conductor comprises:
a rectangular cross-section; and
a U shape.

5. A stator having a structure wherein:
a segment conductor set forth in claim 1 is disposed in a distributed winding in a stator core.

6. A rotating electric machine equipped with the stator as set forth in claim 5.

7. A vehicle equipped with the rotating electric machine as set forth in claim 6.

8. A manufacturing method of a segment conductor that is a conductive element of a coil that is wound in a distributed winding in a stator core of a rotating electric machine comprising the steps of:
press forming a metal material segment conductor provided with a pair of straight conductor portions and
press forming a metal material bent conductor portion that connects together one end side of the pair of straight conductor portions.

9. The method of manufacturing a segment conductor as set forth in claim 8, wherein:
the press forming forms one part of the segment conductor so as to be thinner than another part.

10. The method of manufacturing a segment conductor as set forth in claim 8, wherein:
the press forming forms a part that is exposed from the stator core so as to be thinner than a part that is disposed contained within a slot of the stator core.

11. The method for manufacturing a segment conductor as set forth in claim 9 further comprising the step of:
a punching process, performed after the press forming thickness reducing step.

12. The method for manufacturing a segment conductor as set forth in claim 8, wherein:
the segment conductor is formed from a rectangular wire into a U shape.

13. The method for manufacturing a segment conductor as set forth in claim 12 further comprising the step of:
opening the U-shaped segment conductor.

14. A segment conductor that is a conductive element of a coil that is wound in a distributed winding in a stator core of a rotating electric machine comprising:
a rectangular cross-section,
a pair of straight conductor portions, and
a bent conductor portion that connects together one end side of the pair of straight conductor portions,
wherein a cross-sectional thickness of the part of the bent conductor portion that is disposed exposed from the stator core is thinner than a cross-sectional thickness of the parts of the straight conductor portions that are disposed contained within the slots of the stator core.

15. The segment conductor as set forth in claim 14, wherein:
the parts that are disposed exposed from the stator core are specified to have no more than half the thickness of the parts that are disposed contained within the slots of the stator core.

16. The segment conductor as set forth in claim 14, wherein:
when the segment conductor is disposed in a slot of the stator core, an inclination angle of a part that is disposed exposed from the stator core is specified to be no more than 40°.

17. The segment conductor as set forth in claim 14, wherein:
a cross-sectional area of a part of the bent conductor portion that is disposed exposed from the stator core and a cross-sectional area of a part of the straight conductor portion that is contained within a slot of the stator core are approximately equal.

18. The stator having a structure wherein a segment conductor as set forth in claim 14 is disposed in a distributed winding in a stator core.

19. A rotating electric machine comprising the stator as set forth in claim 18.

20. A vehicle comprising the rotating electric machine as set forth in claim 19.
